(19) United States
(12) Patent Application Publication
(10) Pub. No.: US 2006/0155804 A1
(43) Pub. Date: Jul. 13, 2006

(54) Method for establishing and conducting communication between a data source and a user

(76) Inventor: Conny Larsson, Bjornbacken (SE)

Correspondence Address: YOUNG & THOMPSON, 745 SOUTH 23RD STREET, 2ND FLOOR, ARLINGTON, VA, 22202, US

(21) Appl. No.: 10/534,463

(22) PCT Filed: Nov. 6, 2003
(86) PCT No.: PCT/SE03/01715

§ 371 Date: Oct. 24, 2005

(30) Foreign Application Priority Data
Nov. 12, 2002 (SE) 0203330-6

(51) Int. Cl. G06F 15/16

(52) U.S. Cl. 709/203; 709/217

(57) ABSTRACT

A method of establishing and carrying out communication between a data source and a user, where the communication is effected via a fixed or a mobile network. A program that handles the presentation to a user is placed in a server which is connected to a data source that contains data and which handles data to and from the source such that when receiving information from a user the server clears this information from the layout and protocol and sends to the data source solely interaction data, and, on the other hand, when receiving data from the data source places this data in a correct protocol for presentation to the user on his/her terminal in the right presentation form.

The present invention relates to a method of establishing and carrying out communication between a data source and a user, where said communication is effected via a fixed or a mobile network.

Communication between a data source and a user normally involves the transportation of a large volume of information through the network for presentation on the user's terminal. It has become more usual recently to require information stored somewhere or other, for example in a database in an application in another network, to be presented in different ways, depending on the type of terminal used by the user at that moment in time, for instance in the form of a voice message, an SMS-message, an HTML-message or some like message. If a large volume of information shall be distributed on each occasion, there is created a distribution problem, particularly when the information shall be distributed through the medium of mobile communication.

Hitherto, when presenting information to a user the data source responsible for distribution of the information to respective users sends the information to the user's terminal together with all presentation information. As a result, the volume of information distributed on each occasion becomes very large and complex.

The object of the present invention is to provide an improved method in this regard, that will enable communication to be established and carried out without always needing to transfer as much information as has hitherto been the case.

This object is achieved in accordance with the invention by means of a method in which a program that handles said presentation to the user is placed in a server which is connected to a data source that contains data and that handles data to and from the source such that when receiving information from a user the server clears this information from the layout and protocol and sends to the data source solely interaction data, and, vice versa, when receiving data from the data source places this data in a correct protocol for presentation to the user on his/her terminal in the right presentation form.

As opposed to earlier conventional user communication systems, the inventive method is not primarily directed to the presentation of information to the user, but is directed to the interaction between user and data source.

The programs that manage the user interaction are thus placed in a server, meaning that the data source and its associated computer to be freed from the need to maintain the different interfaces with which data shall be presented to the user. Neither need the data or information be transported to the same extent in both directions through the network. The server includes the programs that handle data from the data source and that places the data in the right layout for presentation to the user. This presentation may, for example, be in the form of a voice message, an SMS-message, an HTML-message or some corresponding message. The server is thus equipped with a program for linking data from the database with the user. However, in conjunction with this linking process, data is placed in the layout that is appropriate for distribution to the user. The server will therefore include several different programs for handling communication with different types of user terminals and for different applications. The programs included in the server may also be designed to sort out data for different applications so as to enable said data to be sent to the data source always in a unitary fashion regardless of application, and so that data obtained from the data source can be converted for presentation in any one of the relevant applications whatsoever, i.e in the form that the user is able to and wishes to receive the information.

The programs included in the server may also be designed to contain a certain amount of dialogue, so that the program is able to proceed to the next stage without needing to send inputted information back to the data source and await an answer therefrom. For instance, this may apply to the presentation on a first page where the user is given the option of choosing between various alternatives and where subsequent dialogue pages that respond to the choices made by the user are stored in the server's program so that such responses can be presented directly to the user without needing to revert back to the data source. Certain other information from the user can be handled in a corresponding manner, and if the program in the server is able to deal with the information from the user it does so in accordance with the instructions found in the program, whereas in any other case the information cleansed from the layout is sent to the data source for an answer.

The dialogue is separated from presentation and layout information in the programs. This enables new presentation media to be readily added to existing applications in the server.

The server is thus able to manage several different applications for different users at one and the same time, and to present these applications to the different users with different interfaces.

Parts of the program included in the server may be identical for different applications and may therewith be used in respect of several different applications. One example of such a program part is a log-in procedure in which the user is given the opportunity of entering his/her user-ID and password in preparation for access to a given service. The program included in the server contains dialogue as to how the user shall log-in and allows the user to enter his/her user-ID and password, this information being separated by the server and forwarded to the application at the data source for verification and to give the user access to further information.

Because the server contains those program parts that handle the presentation of information to the user and that create a user layout and also manage part of the dialogue with the user, it is not necessary to transport this information between the data source and the server, therewith reducing the transmission time and the transmission need between data source and server.

1. A method of establishing and carrying out communication between a data source and a user, where said communication is effected via a fixed or a mobile network, characterised by placing a program that handles said presentation to the user in a server which is connected to a data source that contains data and which handles data to and from the source such that when receiving information from a user the server clears this information from the layout and protocol and sends to the data source solely interaction data, and, on the other hand, when receiving data from the data source places this data in a correct protocol for presentation to the user on his/her terminal in the right presentation form.

2. A method according to claim 1, characterised in that the presentation handling program is independent of the application used by the user.

3. A method according to claim 1, characterised in that the server is adapted to handle several different applications for different users simultaneously.

4. A method according to claim 1, characterised in that the program in the server also includes a dialogue facility which is able to handle user inputs and to respond to the user without reverting back to the data source.

5. A method according to claim 4, characterised in that the dialogue facility is separate from the presentation and layout data in the program.
